(19) United States
(12) Patent Application Publication
(10) Pub. No.: US 2023/0277960 A1
(43) Pub. Date: Sep. 7, 2023

(54) SIEVE PANEL HAVING VARIABLE TILT SCREEN ELEMENT

(71) Applicant: Aqseptence Group, Inc., New Brighton, MN (US)

(72) Inventors: Michael Richard Ekholm, Minneapolis, MN (US); Charles H. Flansburg, Andover, MN (US); Steven A. Danelius, Maple Grove, MN (US)

(73) Assignee: Aqseptence Group, Inc., New Brighton, MN (US)

(21) Appl. No.: 17/926,517

(22) PCT Filed: May 19, 2021
(86) PCT No.: PCT/US2021/033146

§ 371 Date: Nov. 18, 2022

Related U.S. Application Data
(60) Provisional application No. 63/027,087, filed on May 19, 2020.

(51) Int. Cl. B01D 29/44; B01D 29/00; B01D 29/96; C02F 11/121

(52) U.S. Cl. CPC B01D 29/445; B01D 29/0093; B01D 29/965; C02F 11/121; B01D 2201/202

(57) ABSTRACT

A sieve panel and related methods of construction for dewater slurries with shaped-wire elements that have a variable tilt arrangement along the sieve panel. Each of the plurality of shaped-wire elements can be selectively oriented when mounted to a support member to define a desired tilt angle of the shaped-wire element relative to the support members Tilt angle can be selectively varied between an upper end and a lower end of the sieve panel to enhance dewatering characteristics of the sieve panel. The sieve panel can be fabricated such that an upper portion and a lower portion are essentially mirror images of each other such that the sieve panel can be flipped after leading edges of the individual screening elements have suffered wear leading to a degradation in dewatering performance. By flipping the sieve panel, an effective service life of the sieve panel can be essentially doubled.

### FIELD OF THE INVENTION

The present disclosure relates generally to sieve panels for filtering slurries. More specifically, the present disclosure is directed to sieve panels and related methods of fabrication in which screening elements on the sieve panel have a tilt angle that varies based on the relative position of the screening elements on the sieve panel.

### BACKGROUND

Conventional sieve panels are used to separate solids from a carrier medium in a slurry flowing over a screening surface of the sieve bend. The sieve panel is often arcuate and is arranged at an incline with screening apertures, or slots, perpendicular to a direction of flow of the slurry, typically downward, over the screening surface of the sieve bend. As the slurry flows over the inclined screening surface, solids are retained on, and pass along, the screening surface while liquid and other entrained particles of the carrier medium as well as undersized particles pass through the screening slots of the sieve bend. The separated solids retained on the screening surface, and typically collected at a bottom of the sieve panel, are fed downstream for further processing and/or collection while the separated carrier medium can be recycled for re-use.

The carrier medium used in mineral processing applications is generally in the form of magnetite media which is introduced into the mineral handling and preparation circuit to provide appropriate density to volumetric flow. This provides an ability to separate size-specific particles by density due to cyclonic action generated within an upstream separation asset. The cost of this magnetite media is high and recovery of the carrier medium plays a critical part in classifying ores. This general process of dewatering or size separation of slurries is used in other industries such as com wet milling, sugar separation and other applications dependent on slurry control and material separation.

It will be appreciated that inefficient media recovery can result in significant losses for a slurry dewatering operation. Recovery of the carrier medium is directly related to the open area of the sieve panel The greater the open area, the better the efficiency of the sieve panel However, it is desirable to increase open area without increasing slot size. An increased slot size is undesirable as it would result in larger particles passing through the screening slots resulting in an excessive proportion of recoverable solids being lost.

Another major consideration in slurry or material separation processing operations is the cost of the sieve panels themselves. It will be appreciated that the slurry is very abrasive and the slurry impacting on the screening surface of the sieve bend, and the screening elements specifically, adversely affects the operating life of the sieve panel. Extending the wear life of the sieve panel without adversely impacting screening efficiency could result in significant cost savings for the dewatering or slurry processing operation.

### SUMMARY

In representative embodiments of the present disclosure, there is provided a sieve panel which includes a support structure and a variable tilt screening arrangement. The variable tilting arrangement can comprise a plurality of screening elements that are mounted to support members such that the screening elements are arranged in a generally parallel relationship to define slots there between. Each of the plurality of screening elements can be selectively oriented when mounted to the support members to define a desired tilt angle of the screening element relative to the support members. Tilt angle can be selectively varied between an upper end and a lower end of the sieve panel to enhance dewatering characteristics of the sieve panel. In some embodiments, the sieve panel can be fabricated such that the upper portion and lower portion are essentially mirror images of each other. In such an embodiment, the sieve panel can be flipped after leading edges of the individual screening elements have suffered wear leading to a degradation in dewatering performance. By flipping the sieve panel, an effective service life of the sieve panel can be essentially doubled.

In one aspect, the present invention is directed to a sieve panel having individual shaped-wire elements that are selectively mounted to support members such that each shaped-wire element defines a desired tilt angle relative to the support members. The desired tilt angles can be selected so to impart desired dewater characteristics to the sieve panel In some embodiments, a change in tilt angle between adjacent shaped-wire elements can increase rapidly while in other embodiments, the change in tilt angle can be relatively minor depending upon desired dewatering performance and based upon slurry characteristics In some embodiments, the shaped-wire elements can be attached to the support members such that the sieve panel essentially comprises a mirror-imaged upper portion and lower portion such that the sieve panel can be flipped within a gravity filter system following wear to a leading edge of the shaped-wire elements that degrades dewatering performance.

In another aspect, the invention is directed to a method of fabricating a sieve panel to have a desired dewatering performance. The method can involve attaching a plurality of shaped-wire elements to support members, wherein each shaped-wire element is oriented to define a desired tilt angle relative to the support members. The method can further comprise fabricating the sieve panel to have an upper portion and a lower portion, wherein the upper portion and the lower portion are essentially mirror images of each other. The method can further choosing a rate of change in tilt angle between adjacent shaped-wire elements to affect a desired dewatering performance

The above summary is not intended to describe each illustrated embodiment or every implementation of the subject matter hereof. The figures and the detailed description that follow more particularly exemplify various embodiments.

### BRIEF DESCRIPTION OF THE FIGURES

Subject matter hereof may be more completely understood in consideration of the following detailed description of various embodiments in connection with the accompanying figures, in which:

FIG. 1 is a perspective view of a conventional pressure fed filter of the prior art.

FIG. 2 is a perspective view of a conventional sieve panel of the prior art.

FIG. 3a is a side view of a representative sieve panel of the present invention.

FIG. 3b is a side view of a representative sieve panel of the present invention.

FIG. 4 is a side view of a shaped-wire element attached to a support member according to the prior art.

FIG. 5 is a side view of a shaped-wire element attached to a support member illustrating a tilt angle according to the present invention.

FIG. 6 is a side view illustration operation of the sieve panel of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE FIGURES

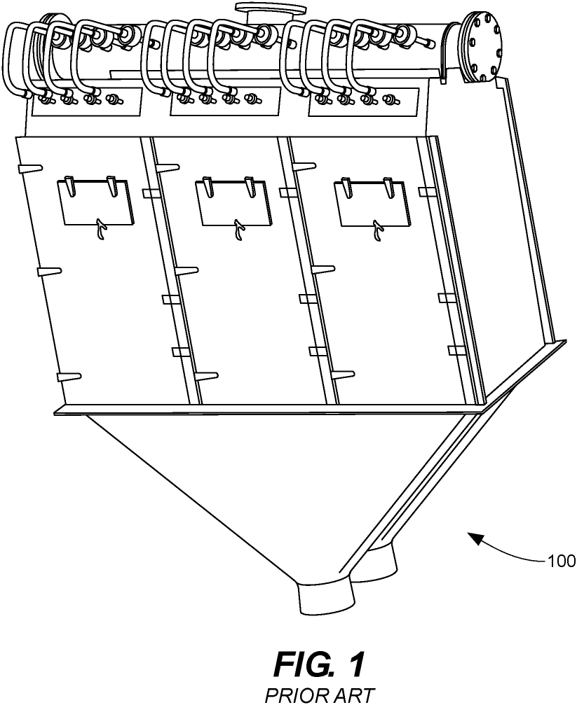

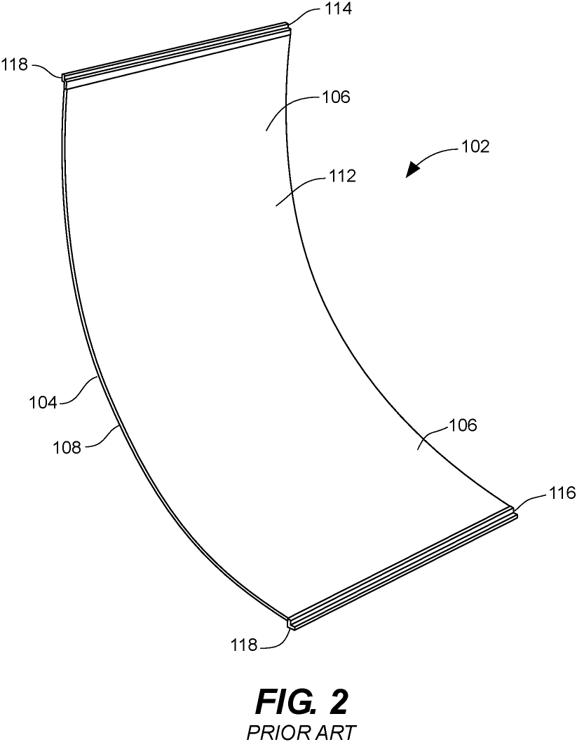

Referring generally to FIGS. 1 and 2, a conventional pressure fed filtration system 100 of the prior art generally utilizes a screening panel 102 defining an arcuate profile 104. The screening panel 102 generally includes a plurality of screening elements 106 that are mounted to an underlying support structure 108. The screening panel 102 generally defines an upper screening surface 112 that extends between an upper end 114 and a lower end 116. Upper screening surface 112 generally defines a number of openings or “slots” over which a slurry is passed and dewatered Upper end 114 and lower end 116 can comprise mounting members 118 such as, for example, angled bars or flanges for otherwise coupling and retaining the sieve panel 100 during use. In operation, and as described previously, a slurry will generally be introduced onto the sieve panel 100 at upper end 114 and will flow by gravity toward lower end 116. As the slurry flows down the screening panel 102 and over the upper screening surface 112, liquid and entrained particles smaller than the openings/slots will flow through the upper screening surface 112, while particles larger than the openings/slots travel along the upper screening surface 112 such that they are essentially concentrated at lower end 116 of the screening panel 102 for subsequent processing.

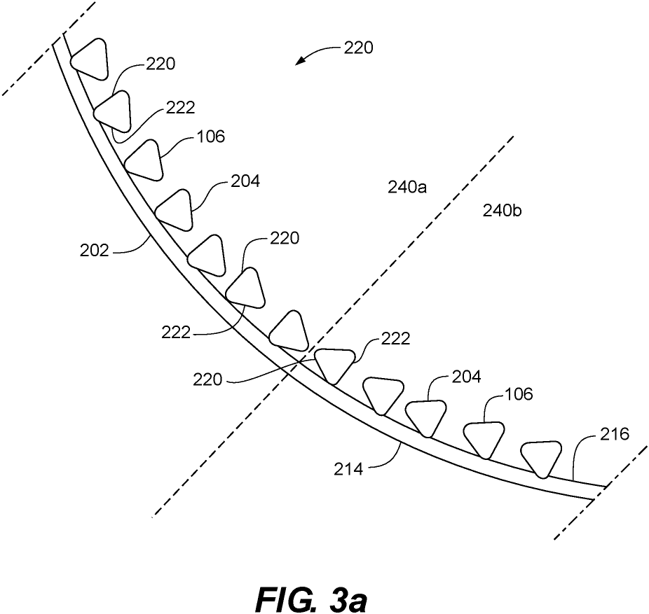

Referring now to FIGS. 3a and 3b, a sieve panel 200 of the present invention can substantially resemble sieve panel 100 when viewed from a distance and can be installed and operated in a like manner. The improvements in performance and longevity are generally related to the fabrication of a screening panel 202 on the sieve panel 200, and more specifically, the attachment and relation of screening elements 106 between upper end 114 and lower end 116.

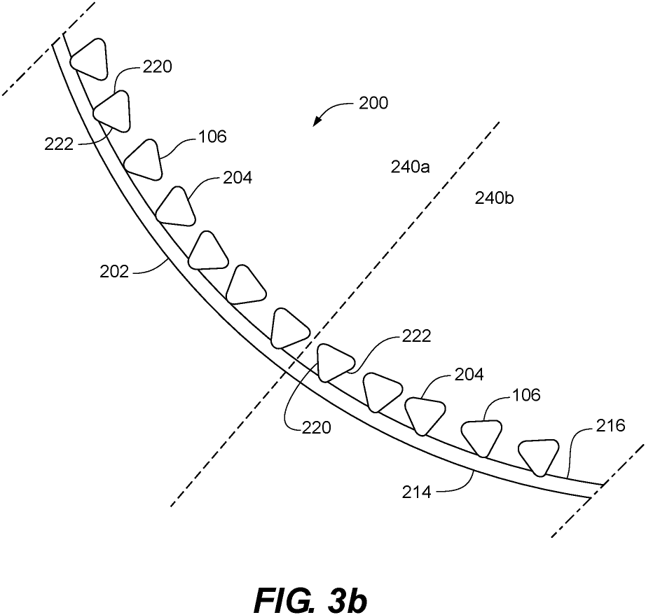

As shown in FIG. 4, screening elements 106 preferably comprise a shaped-wire element 204 often referred to as a wedge or Vee-wire®. Shaped-wire element 204 typically has a vee-shaped or triangular cross-section 206 defining an attachment point 208, a pair of wire sides 210a, 210b and an element surface 212. Element surface 212 defines a generally flat surface defining an element plane 213 and having an element width 211 defined between the intersections with the wires sides 210a, 210b. Each screening element 106 is attached to a plurality of arcuate support rods 214 that extend from the upper end 114 to the lower end 116. The plurality of arcuate support rods 214 lie in generally parallel relation relative to one another and cooperatively define an arcuate support surface 216. The shaped-wire elements 204 are attached to the support rods 214 at attachment point 208 by welding the shaped-wire element 204 in a perpendicular orientation to the support rods 214 so as to define screening slots 110 with a slot width 215 between each adjacent shaped-wire element 204. Typically, the shaped-wire elements 204 can be attached to support rods based on the same principles as disclosed in U.S. Pat. Nos. 6,663,774 and 7,425,264, both of which are hereby incorporated by reference in their entirety.

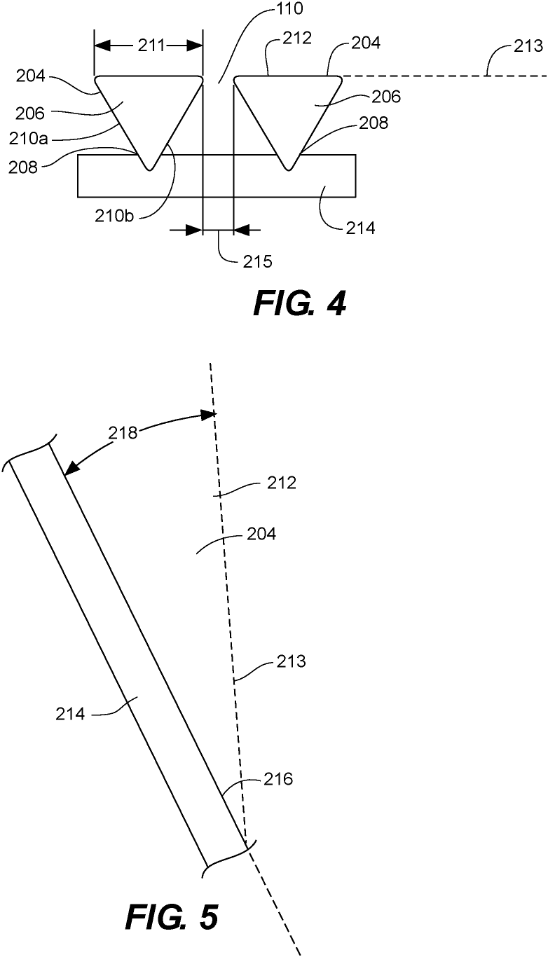

Referring to FIG. 5, the mounting orientation of each shaped-wire element 204 relative to the arcuate support rods 214 and more specifically the intersection of element plane 213 and the arcuate support surface 216 defines a tilt angle 218. In the present invention, the sieve panel 200 is fabricated such that the tilt angle 218 can be selectively varied along the screening panel 202 between upper end 114 and lower end 116. Essentially, each shaped-wire element 204 can be oriented prior to being welded to the support rods 214 such that the desired tilt angle 218 is achieved. An induced angle from an asymmetrical wire shape can also be used to achieve the same effect. Based on slurry characteristics and desired dewatering performance, it may be advantageous to fabricate sieve panel 200 such that the tilt angle 218 has a rapid rate of change between adjacent shaped-wire elements 204 as seen in FIG. 3a while in other circumstances, it can be desirable to have a reduced tilt angle 218 rate of change between adjacent shaped-wire elements 204 as seen in FIG. 3b.

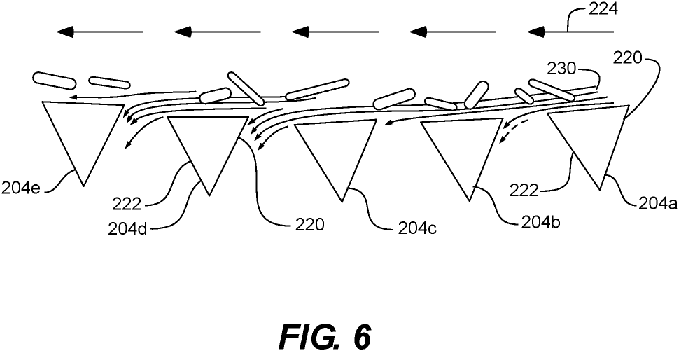

Dewatering using the sieve panel 200 is generally illustrated in FIG. 6 wherein a slurry flow 230 flows along upper screen surface 112. On a right side of FIG. 6, shaped-wire elements 204a, 204b and 204c are oriented so as to have the same tilt angle 218 while shaped-wire elements 204d and 204e are oriented to define sequentially different tilt angles 218. As the slurry flow 230 moves across the upper screen surface 112, the wire sides 210a, 210b essentially define a leading edge 220 and trailing edge 222 relative to a flow direction 224 of the slurry flow 230. With the tilt angle 218 substantially the same for shaped-wire elements 204a, 204b, 204c, the leading edge 220 does not substantially project into the slurry flow 230 resulting in a generally laminar flow pattern across the shaped-wire elements 204a, 204b, 204c. As seen with shaped-wire elements 204d, 204e, sequential adjustment of the tilt angle 218 allows the leading edge 220 to project into the slurry flow 230 resulting in a disruption to the generally laminar flow pattern and increasing the amount of water flow through the slots 110. By sequentially adjusting the tilt angle 218 between the upper end 114 and lower end 116, the amount of water removed from the slurry flow 230 is increased resulting in a higher concentration of particulate matter at lower end 216.

While adjustments to the tilt angle 218 can increase dewatering performance for sieve panel 200, it will be understood that the pronounced extension of the leading edge 220 into the slurry flow 230 can lead to increased wear and tear on leading edge 220 such that dewatering performance can degrade over time. In certain embodiments of the invention shown in FIGS. 3a and 3b, it will be understood that sieve panel 200 can be fabricated to have an upper portion 240a and a lower portion 240b that essentially divide the sieve panel in half between the upper end 114 and lower end 116. The upper portion 240a and lower portion 240b, and more specifically, the individual orientation of the shaped-wire elements 204 and their selected tilt angles 218, can be fabricated such that the upper portion 240a and lower portion 240b are mirror images of one another. Therefore, when the leading edges 220 of the upper portion 240a and lower portion 240b experience wear that degrades their performance, the sieve panel 200 can be flipped within the gravity filtration system 100 such that the lower portion 240b is now proximate the upper end 114 and the upper portion 240a is now proximate the lower end 116. In this flipped arrangement, the prior trailing edges 222 that have experienced little to no wear now become the leading edges 220 and the sieve panel 200 again operates with the desired performance. In this manner, sieve panel 200 has essentially twice the operational life of a conventional panel that cannot be flipped.

Alternative configurations that include additional variable intervals of wire tilt orientation, where multiple sections of the sieve panel have either continuous or sudden adjustments in relative tilt angle relative to the slurry flow are possible.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A sieve panel, comprising:
a plurality of shaped-wire screen elements mounted to one or more support members to define an upper panel end and a lower panel end, the plurality of shaped-wire screen elements arranged in a generally parallel relationship to define slots between adjacent shaped-wire screen elements, each shaped wire element coupled to the one or more support members to selectively define a tilt angle of each shaped-wire screen element relative to the one or more support members.

2. The sieve panel of claim 1, wherein the tilt angle varies between the upper panel end and the lower panel end.

3. The sieve panel of claim 2, wherein a rate of change of the tilt angle varies between the upper panel end and the lower panel end.

4. The sieve panel of claim 1, wherein the plurality of shaped-wire screen elements mounted to one or more support members define an upper panel portion proximate the upper panel end and a lower panel portion proximate the lower panel end, wherein the upper panel portion and the lower panel portion are mirror images of each other such that the upper panel end and lower panel end can be flipped to extend service life.

5. The sieve panel of claim 1, wherein the tilt angle of each shaped-wire screen element is selected to project a leading edge of each shaped-wire screen element into a slurry flow to increase a liquid flow through the slots.

6. The sieve panel of claim 1, wherein each shaped-wire screen element comprises a wedge wire of Vee-wire®.

7. A pressure fed filter, comprising the sieve panel of claim 1.

8. A method of fabricating a sieve panel for a pressure fed filter, comprising:
coupling a plurality of shaped-wire screen elements to one or more support members so as to define a to define an upper panel end and a lower panel, the plurality of shaped-wire screen elements arranged in a generally parallel relationship to define slots between adjacent shaped-wire screen elements, each shaped wire element joined to the one or more support members to selectively define a tilt angle of each shaped-wire screen element relative to the one or more support members.

9. The method of claim 8, further comprising:
varying the tilt angle of each shaped-wire screen element between the upper panel end and the lower panel end.

10. The method of claim 9, further comprising:
varying a rate of change of the tilt angle between the upper panel end and the lower panel end.

11. The method of claim 8, further comprising:
defining an upper panel portion proximate the upper panel end; and
defining a lower panel portion proximate the lower panel end,
wherein the upper panel portion and the lower panel portion are mirror images of each other such that the upper panel end and lower panel end can be flipped to extend service life.

12. The method of claim 8, further comprising:
selecting the tilt angle of each shaped-wire screen element such that a leading edge of each shaped-wire screen element is selectively configured to project into a slurry flow.

13. A method for dewatering a slurry, comprising:
directing a slurry flow across a sieve panel in a pressure fed filter, the sieve panel having a plurality of shaped-wire screen elements attached to one or more support members so as to define an upper panel end and a lower panel end, the plurality of shaped-wire screen elements arranged in a generally parallel relationship to define slots between adjacent shaped-wire screen elements, each shaped wire element joined to the one or more support members to selectively define a tilt angle of each shaped-wire screen element relative to the one or more support members; and
removing liquid from the slurry flow through the slots.

14. The method of claim 13, wherein the tilt angle of each shaped-wire screen element is varied between the upper panel end and the lower panel end.

15. The method of claim 14, further comprising:
varying a rate of change of the tilt angle between the upper panel end and the lower panel end.

16. The method of claim 13, wherein the sieve panel includes an upper panel portion proximate the upper panel end and a lower panel portion proximate the lower panel end, wherein the upper panel portion and the lower panel portion are mirror images of each other.

17. The method of claim 16, further comprising:
extending a service life of the sieve panel by flipping the upper panel end and the lower panel end.

18. The method of claim 13, further comprising:
selecting the tilt angle of each shaped-wire screen element such that a leading edge of each shaped-wire screen element is selectively configured to project into the slurry flow.
